(19) United States
(12) Patent Application Publication
(10) Pub. No.: US 2026/0172343 A1
(43) Pub. Date: Jun. 18, 2026

(54) MITIGATING ASYMMETRIC TRAFFIC

(71) Applicant: INTERNATIONAL BUSINESS MACHINES CORPORATION, ARMONK, NY (US)

(72) Inventors: Chang Chen, Cedar Park, TX (US); Ming Shuang Xian, Wuxi (CN); Zhi Hui Huang, Shanghai (CN); Samarendra Chakraborty, Bengaluru (IN)

(21) Appl. No.: 18/986,196

(22) Filed: Dec. 18, 2024

(51) Int. Cl. H04L 45/00; H04L 12/66

(52) U.S. Cl. CPC H04L 45/22; H04L 12/66

(57) ABSTRACT

Provided are techniques for mitigating asymmetric traffic between a public cloud network and an on-premise gateway, where the public cloud network includes a first cloud gateway and a second cloud gateway. The second cloud gateway receives a response packet from an on-premise gateway, where the response packet corresponds to a request packet from a virtual machine of the public cloud network that was routed through the first cloud gateway to the on-premise gateway. The second cloud gateway determines that the response packet is to be redirected to the first cloud gateway based on checking a session table at the second cloud gateway. The second cloud gateway forwards the response packet to the first cloud gateway using an intra-tunnel, where the first cloud gateway forwards the response packet to the virtual machine of the public cloud network.

### BACKGROUND

Embodiments of the invention relate to mitigating asymmetric traffic between, for example, a public cloud network and an on-premise gateway.

The public cloud network may be described as computing services offered by third-party providers over a network (e.g., the public Internet), making the computing services available to anyone who wants to use or purchase them. The computing services may be free or sold on-demand, allowing customers to pay per usage for the Central Processing Unit (CPU) cycles, storage, or bandwidth they consume.

In addition to the public cloud network, users may have an on-premise data center. A hybrid cloud may be described as the public cloud network connected to the on-premise data center. Commonly, users connect the public cloud network and the on-premise data center to each other through the network to enable communication between them.

The connection between the public cloud network and the on-premise data center is established through a first cloud gateway, a second cloud gateway, and an on-premise gateway. The public cloud network includes Virtual Machine 1(VM1 ), while the on-premise data center includes Virtual Machine 2 (VM2).

To achieve high availability of the network and increase bandwidth, two paths are established between the public cloud network and the on-premise data center (i.e., one path through the on-premise gateway and the first cloud gateway and another path through the on-premise gateway and the second cloud gateway. Packets are send along these two paths.

However, since there are two forwarding paths between the public cloud network and the on-premise data center, it is possible that the packet forwarding and return paths are different. For example, VM1 may forward packets to VM2 through the first cloud gateway, and VM2 forwards the response packets to VM1 through the second cloud gateway. A network whose forwarding and return paths are different performs asymmetric routing.

### SUMMARY

In accordance with certain embodiments, a computer-implemented method comprising operations is provided for mitigating asymmetric traffic between a public cloud network and an on-premise gateway, where the public cloud network includes a first cloud gateway and a second cloud gateway. In such embodiments, the second cloud gateway receives a response packet from an on-premise gateway, where the response packet corresponds to a request packet from a virtual machine of the public cloud network that was routed through the first cloud gateway to the on-premise gateway. The second cloud gateway determines that the response packet is to be redirected to the first cloud gateway based on checking a session table at the second cloud gateway. The second cloud gateway forwards the response packet to the first cloud gateway using an intra-tunnel, where the first cloud gateway forwards the response packet to the virtual machine of the public cloud network.

In accordance with other embodiments, a computer program product comprising a computer readable storage medium having program code embodied therewith is provided, where the program code is executable by at least one computer processor to perform operations for mitigating asymmetric traffic between a public cloud network and an on-premise gateway, where the public cloud network includes a first cloud gateway and a second cloud gateway. In such embodiments, the second cloud gateway receives a response packet from an on-premise gateway, where the response packet corresponds to a request packet from a virtual machine of the public cloud network that was routed through the first cloud gateway to the on-premise gateway. The second cloud gateway determines that the response packet is to be redirected to the first cloud gateway based on checking a session table at the second cloud gateway. The second cloud gateway forwards the response packet to the first cloud gateway using an intra-tunnel, where the first cloud gateway forwards the response packet to the virtual machine of the public cloud network.

In accordance with yet other embodiments, a computer system comprises one or more computer processors, one or more computer-readable memories and one or more computer-readable, tangible storage devices; and program instructions, stored on at least one of the one or more computer-readable, tangible storage devices for execution by at least one of the one or more computer processors via at least one of the one or more memories, to perform operations for mitigating asymmetric traffic between a public cloud network and an on-premise gateway, where the public cloud network includes a first cloud gateway and a second cloud gateway. In such embodiments, the second cloud gateway receives a response packet from an on-premise gateway, where the response packet corresponds to a request packet from a virtual machine of the public cloud network that was routed through the first cloud gateway to the on-premise gateway. The second cloud gateway determines that the response packet is to be redirected to the first cloud gateway based on checking a session table at the second cloud gateway. The second cloud gateway forwards the response packet to the first cloud gateway using an intra-tunnel, where the first cloud gateway forwards the response packet to the virtual machine of the public cloud network.

### BRIEF DESCRIPTION OF THE DRAWINGS

Referring now to the drawings in which like reference numbers represent corresponding parts throughout:

FIG. 1 illustrates a computing environment in accordance with certain embodiments.

FIG. 2 illustrates a computing environment for mitigating asymmetric traffic in accordance with certain embodiments.

FIG. 3 illustrates an example session table in accordance with certain embodiments.

FIG. 4 illustrates an example implementation in accordance with certain embodiments.

FIGS. 5A-5E illustrate, in a flowchart, operations for traffic that originates at the public cloud network in accordance with certain embodiments.

FIGS. 6A-6E illustrate, in a flowchart, operations for traffic that originates at the on-premise gateway in accordance with certain embodiments.

FIG. 7 illustrates, in a flowchart, operations for mitigating asymmetric traffic in accordance with certain embodiments.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

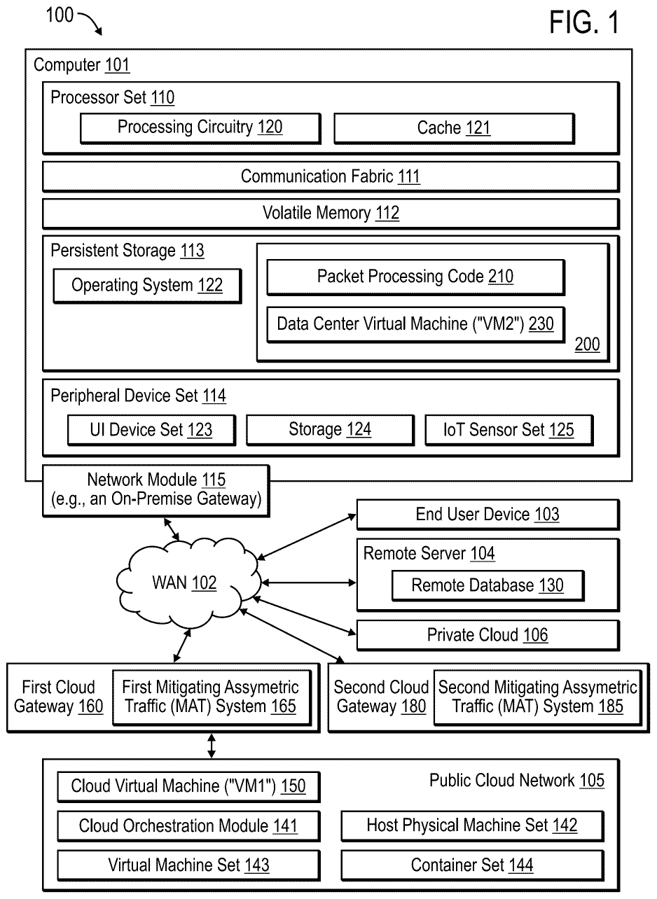

Computing environment 100 of FIG. 1 contains an example of an environment for the execution of at least some of the computer code involved in performing the inventive methods, such as data processing code 210 and Data Center Virtual Machine (“VM2”) 230 of block 200. In addition to block 200, computing environment 100 includes, for example, computer 101, wide area network (WAN) 102, end user device (EUD) 103, remote server 104, public cloud network 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115 (which may be an on-premise gateway). Remote server 104 includes remote database 130. Public cloud network 105 connects to the WAN 102 via cloud gateway 160 or cloud gateway 180, cloud orchestration module 141, host physical machine set 142, virtual machine set 143, container set 144, and a cloud Virtual Machine (“VM1”). Cloud gateway 160 includes Mitigating Asymmetric Traffic (MAT) system 165, and cloud gateway 180 includes MAT system 185.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set 110 may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may be an on-premise gateway. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD NETWORK 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud network 105 is performed by the computer hardware and/or software of cloud orchestration module 141. The computing resources provided by public cloud network 105 are typically implemented by virtual computing environments that run on various computers making up the computers of host physical machine set 142, which is the universe of physical computers in and/or available to public cloud network 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Cloud gateway 160 and cloud gateway 180 are each the collection of computer software, hardware, and firmware that allows public cloud network 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud network 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud network types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud network 105 and private cloud 106 are both part of a larger hybrid cloud.

CLOUD COMPUTING SERVICES AND/OR MICROSERVICES (not separately shown in FIG. 1): private cloud 106 and public cloud network 105 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

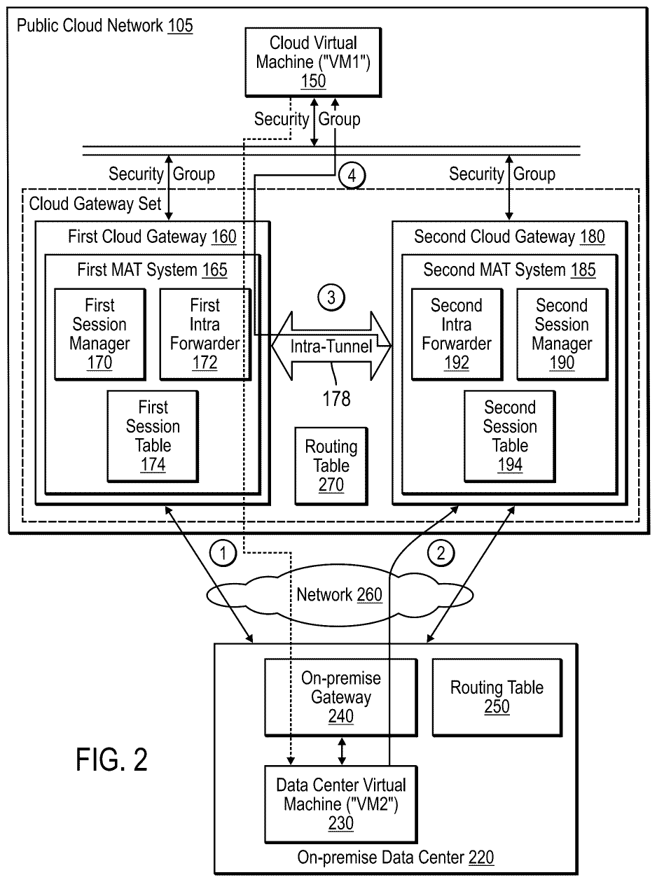

FIG. 2 illustrates a computing environment for mitigating asymmetric traffic in accordance with certain embodiments. In FIG. 2, a public cloud network 105 is connected to an on-premise data center 220 via a network 260. The network 260 may be any communication network, such as the Internet. Traffic (i.e., one or more data packets) are sent between the public cloud network 105 and the on-premise data center 220.

The public cloud network 105 includes a cloud Virtual Machine (“VM1”) 150, which is connected to a first cloud gateway 160 and to a second cloud gateway 180. The first cloud gateway 160 and the second cloud gateway 180 form a cloud gateway set.

The first cloud gateway 160 includes a first MAT system 165. The first MAT system 165 includes a first session manager 170, a first intra forwarder 172, and a first session table 174. The second cloud gateway 180 includes a second MAT system 185. The second MAT system 185 includes a second session manager 190, a second intra forwarder 192, and a second session table 194. The first cloud gateway 160 and the second cloud gateway 180 are connected with an intra-tunnel 178.

The on-premise data center 220 includes a data center Virtual Machine (“VM2”) 250 and an on-premise gateway 240.

In certain embodiments, VM1 150 and VM2 230 each include or work with packet processing code to send, receive, and process packets.

The on-premise gateway 240 may use routing table 250 to determine whether to route a packet through the first cloud gateway 160 or the second cloud gateway 180 to get to the destination VM1 150. The first cloud gateway 160, the second cloud gateway 180 and/or the intra-tunnel may use routing table 270 to determine a route for a packet to VM1 or VM2. Each routing table 250, 270 may be described as a table that lists routes to a destination along with metrics associated with the routes.

The new components 170, 172, 174 of the first MAT system 165, the new components 190, 192, and 194 of the second MAT system 185, and the new component intra-tunnel 178 work together to enable better traffic monitoring when there is asymmetric routing.

In particular, embodiments introduce the new components to monitor the traffic forwarded through the first cloud gateway 160, the second cloud gateway 180, and the on-premise gateway 240. If asymmetric routing is detected on either the first cloud gateway 160 or the second cloud gateway 180, embodiments redirect traffic to the other cloud gateway 160, 180 through the intra-tunnel 178 between the first and second cloud gateways 160, 180, and then the sibling cloud gateway 160, 180 will route traffic to VM1 150 or VM2 230.

For example, in FIG. 2, the communication mode between VM1 and VM2 is as follows:
1: The public cloud network 105 forwards an initial packet from VM1 150 to the first cloud gateway 160, and the first cloud gateway 160 forwards the initial packet to the on-premise gateway 240, and the on-premise gateway 240 forwards the initial packet to VM2 230.
2: VM2 230 generates a response packet (i.e., a return packet) to the initial packet. VM2 230 forwards the response packet to the on-premise gateway 240, the on-premise gateway 240 forwards the response packet to the second cloud gateway 180 according to a routing technique that identifies the second cloud gateway 180. The routing technique may be described as a process that selects a path for a packet to travel from a source to a destination. For example, the routing technique may determine a path that includes the second cloud gateway 180 for a packet to travel from the VM2 230 to the VM1 150.
3: The second intra forwarder 192 of the second cloud gateway 180 sees no session information for the response packet in the second session table 194 and determines that the response packet should be forwarded by the first cloud gateway 160 to VM1 150 of the public cloud network 105. The second intra forwarder 192 sends the response packet to the first intra forwarder 172 via the intra-tunnel 178.
4: The first intra forwarder 172 receives the response packet. The first intra forwarder 172 of the first cloud gateway 160 determines that there is session information for the response packet in the first session table 174 and forwards the response packet back to VM1 150 of the public cloud network 105.

In this manner, from the perspective of the public cloud network 105, the traffic (i.e., packets, such as the initial packet and the response packet) is sent and received from the same cloud gateway 160, 180, which avoids the problem of asymmetric routing. At the same time, compared with existing solutions, embodiments provide new components on the cloud gateways 160, 180, without any modification on the on-premise gateway 240, and has better applicability.

In certain embodiments, the intra-tunnel 178 implements traffic forwarding between the cloud gateways 160, 180. Any type of tunnel may be used for the intra-tunnel 178. For example, the intra-tunnel may be an Internet Protocol (IP) over IP (IPIP) tunnel, a Simple Internet Transition (SIT) tunnel, an IPv4/IPv6 over IPv6 (ip6tnl) tunnel, a Virtual Tunnel Interface (VTI) tunnel, a Generic Routing Encapsulation (GRE) tunnel, foo over User Datagram Protocol (UDP) (FOU) tunnel, etc. The packet includes various components based on the protocol.

In certain embodiments, the packet includes a header, a payload, and a trailer. The header indicates whether the packet is for a request or for a response, identifies the sender (i.e., the public cloud network 105 or the on-premise gateway 240), identifies the destination (i.e., receiver or target), and may include other information. The payload includes the data of the packet (e.g., text, an image, a video, audio, etc.). The trailer indicates the ending of the packet and may include other information.

The intra-forwarder 172, 192, when receiving a packet from the on-premise gateway 240, instead of directly forwarding the packet to VM1 150 of the public cloud network 105, the intra-forwarder 172, 192 first looks up the session table 174, 194. Based on the session table 174, 194 not including session information for the packet, the intra-forwarder 172, 192 redirects the packet to the sibling cloud gateway 160, 180. Based on the session table 174, 194 including session information for the packet, the intra-forwarder 172, 192 continues the lookup of a routing table 270 and routes the packet to VM1 150 of the public cloud network 105.

In addition to the behavior of redirect (to sibling gateway 160, 180) or route to VM1 150, if the packet is the first packet received from the on-premise gateway 240, the session manager 170, 190 asks the intra-forwarder 172, 192 to route the packet to VM1 150 of the public cloud network 105, meanwhile mirroring the packet to another cloud gateway.

In certain embodiments, the session manager 170, 190 monitors the traffic forwarded by the cloud gateways 160, 180. The session manager 170, 190 also monitors receiving traffic from the on-premise gateway 240. According to the packet characteristics of the traffic flow and its session information, the session manager 170, 190 divides these packets into three categories and stores the corresponding session information in the session table 174, 194.

In FIG. 2, the security groups may be described as tools that monitor and control traffic to and from resources that are associated with the security groups. With embodiments, since traffic is redirected so that the forward path and the return path use the same, originating gateway, the security groups are able to properly monitor and control traffic.

In the following description, cloud gateways A and B refer to the cloud gateway pair 160, 180 with intra-tunnel 178. The public cloud network 105 refers to the cloud network including the cloud gateway pair 160, 180 with intra-tunnel 178. In certain embodiments, cloud gateway A may be the first cloud gateway 160, while cloud gateway B may be the second cloud gateway 180. In other embodiments, cloud gateway A may be the second cloud gateway 180, while cloud gateway B may be the first cloud gateway 160.

In certain embodiments, a packet is initiated from VM1 150 of the public cloud network 105 and forwarded by cloud gateway A to the on-premise gateway 240, and the on-premise gateway 240 returns a response packet to the same cloud gateway A. With embodiments, for this kind of response packet, cloud gateway A routes the response packet to VM1 150 of the public cloud network 105 according to a normal route result. In addition, the session manager of cloud gateway A creates a record in the session table of cloud gateway A when cloud gateway A receives the packet from VM1 150 of the public cloud network 105. When the response packet is received from the on-premise gateway 240, the intra forwarder of cloud gateway A looks up the session table of cloud gateway A for a record of the session information about the response packet. If the lookup is successful in finding a record of the session information, the intra forwards of cloud gateway A indicates that the response packet belongs to a route category of traffic. At the same time, the session manager of cloud gateway A updates the record by marking the category of traffic as the route category in the session table of cloud gateway A. Then, cloud gateway A routes the response packet to VM1 150 of the public cloud network 105.

In certain embodiments, a packet is initiated from VM1 150 of the public cloud network 105 and forwarded by cloud gateway A to the on-premise gateway 240, and the on-premise gateway 240 returns a response packet to cloud gateway B. With embodiments, this kind of packet is redirected from cloud gateway B to cloud gateway A. In particular, when cloud gateway B receives the packet from the on-premise gateway 240 and the session manager of cloud gateway B cannot find a corresponding record in the session table of cloud gateway B for the response packet, the session manager of cloud gateway B creates a new record in the session table of cloud gateway B and marks the category of traffic as the redirect category in the session table of cloud gateway B. When a packet of the same session is received another (e.g., a next) time, the intra forwarder of cloud gateway B checks the session table of cloud gateway B, finds the record marked redirect, and redirects the packet to cloud gateway A.

In certain embodiments, a first packet is initiated from the on-premise gateway 240 and reaches cloud gateway A. For the first packet of the session from the on-premise gateway 240, since it is not known which cloud gateway the public cloud network 105 will return the packet to later, cloud gateway A routes the first packet to VM1 150 of the public cloud network 105 and at the same time mirrors (i.e., forwards) the first packet to cloud gateway B. In addition, the session manager of cloud gateway A creates a record in the session table of cloud gateway A with the category set to route. If VM1 150 of the public cloud network 105 returns the response to cloud gateway A, the subsequent packets of this session are directly routed to the public cloud network 105. If the public cloud network 105 returns the response packet to cloud gateway B, then the intra forwarder of cloud gateway B redirects the subsequent packets to cloud gateway A. In particular, when cloud gateway B receives the mirrored packet from cloud gateway A and the session manager of cloud gateway B cannot find a corresponding record in the session table of cloud gateway B for the request packet, the session manager of cloud gateway B creates a new record in the session table of cloud gateway B and marks the category of traffic as the redirect category in the session table of cloud gateway B.

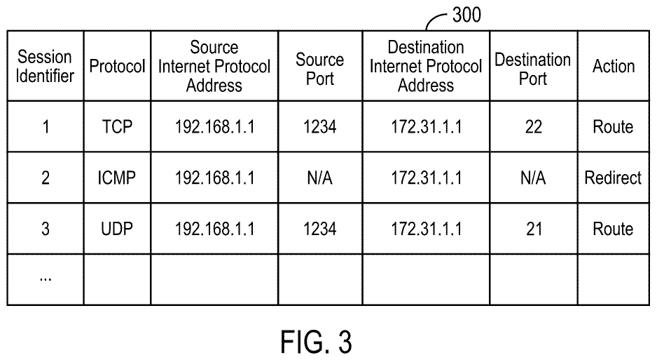

FIG. 3 illustrates an example session table 300 in accordance with certain embodiments. The session table 300 includes columns for session identifier, protocol, source Internet Protocol (IP) address, source port, destination IP address, destination port, and action. Session table 300 is an example of a session table 174, 194. The session manger generates and updates the session table 300 according to the session information monitored by the session manager.

For example, the session table 300 includes records for sessions with session identifiers 1, 2, 3. The ellipses indicate that there may be other records in the session table 300. In certain embodiments, a session identifier is used to identify a session entry, and multiple packets may be associated with that session identifier. In certain embodiments, a session with a session identifier may be associated with one or more processes that send packets that are associated with that session identifier

The protocol describes how the packet is sent between devices. Examples of protocols in the session table 300 are Transmission Control Protocol (TCP), Internet Control Message Protocol (ICMP), and User Datagram Protocol (UDP).

The source IP address may be described as the IP address of the source device (i.e., VM1 150 or VM2 230) that sends a packet.

The source port may be described as a number that is used by a process to send a packet.

The destination IP address may be described as the IP address of the destination device (i.e., VM1 150 or VM2 230) that receives the packet.

The destination port may be described as a number that indicates which application is to receive the packet.

The action indicates whether to route or redirect the packet.

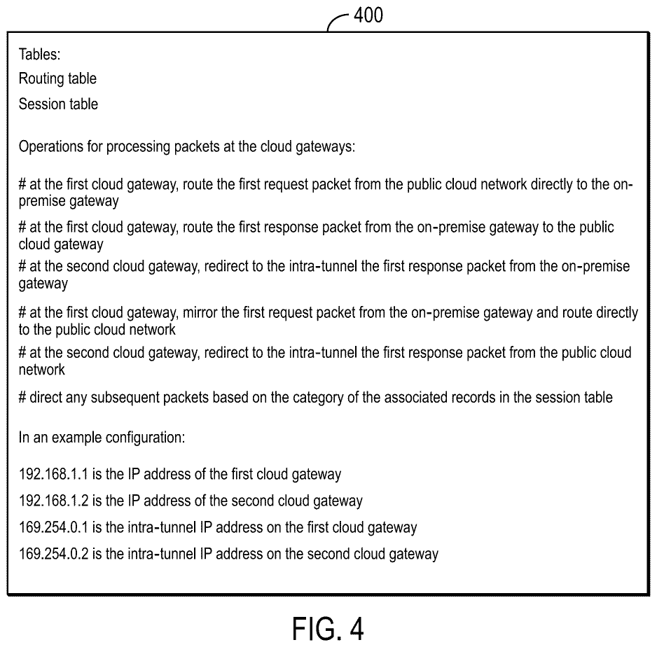

FIG. 4 illustrates an example implementation 400 in accordance with certain embodiments. FIG. 4 indicates that a routing table and a session table are used to route packets. In addition, FIG. 4 describes various operations for processing packets.

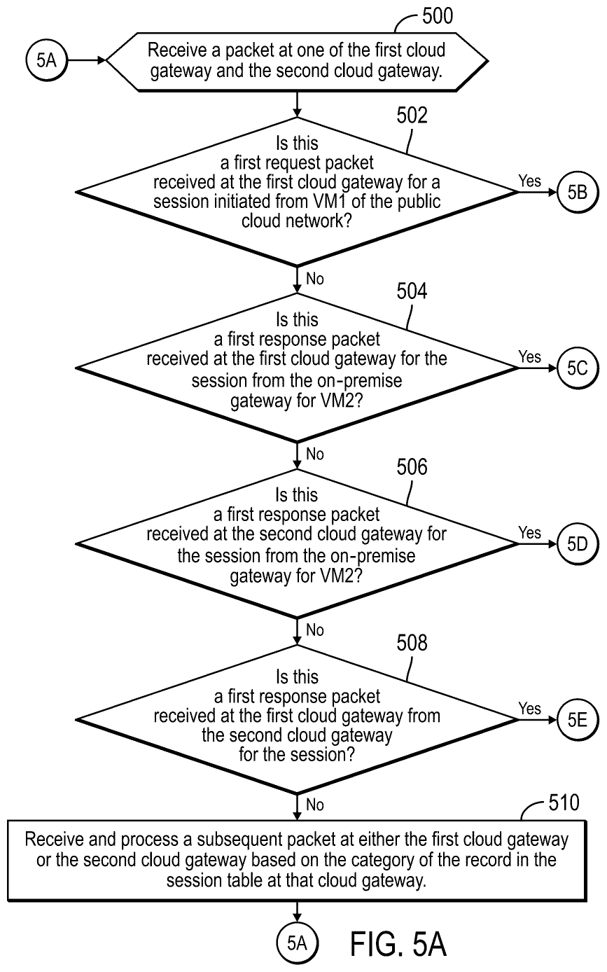

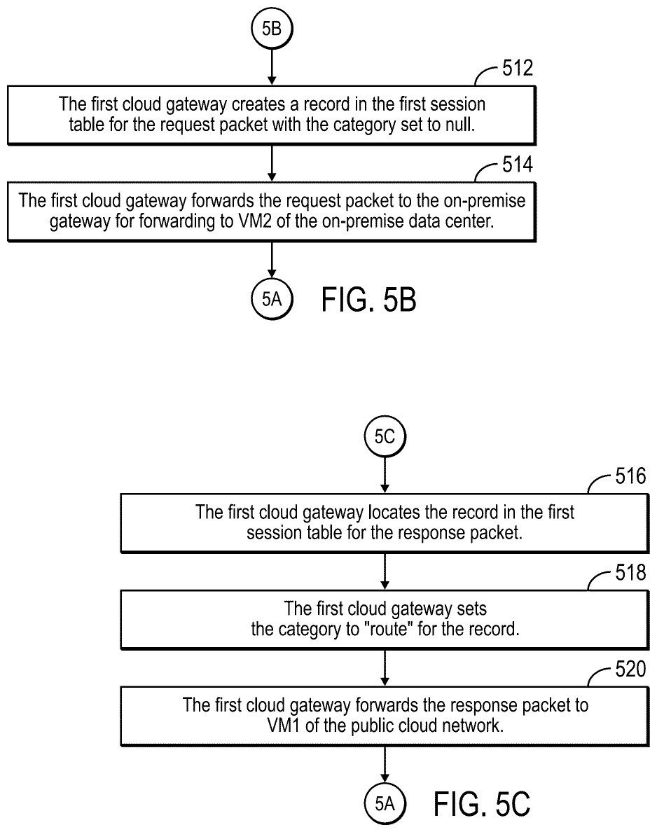

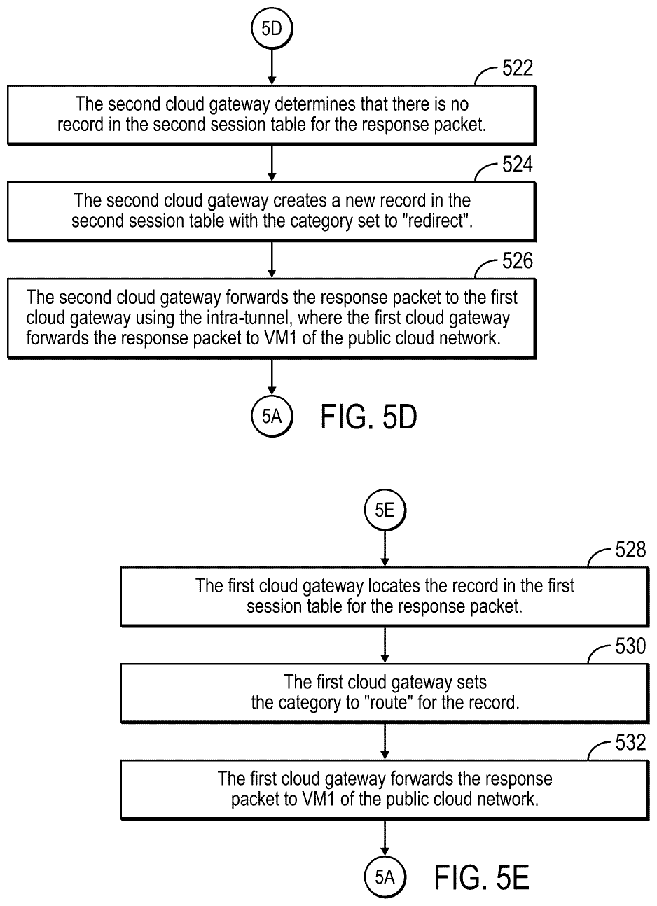

FIGS. 5A-5E illustrate, in a flowchart, operations for traffic that originates at the public cloud network 105 in accordance with certain embodiments. Control begins at block 500 with a packet being received at one of the first cloud gateway 160 and the second cloud gateway 180.

In block 502, the first cloud gateway 160 determines whether this a first request packet received at the first cloud gateway 160 for a session initiated from VM1 150 of the public cloud network 105. If this is the first request packet for a session initiated from the public cloud network 105, then processing continues to block 512 (FIG. 5B), otherwise, processing continues to block 504.

The determination of block 502 may be made using the header of the packet to determine that this packet is a request packet and came from the public cloud network 105. In addition, the first session manager 170 of the first cloud gateway 160 checks the first session table 174. If a record for the session is not in the first session table 174 for the packet, then this is the first request, and, if there is a record for the session in the first session table 174 for the packet, then this is not the first request.

In block 504, the first cloud gateway 160 determines whether this a first response packet received at the first cloud gateway 160 for the session from the on-premise gateway 240. If this is the first response packet received for the session from an on-premise gateway 240, processing continues to block 516 (FIG. 5C), otherwise, processing continues to block 506.

The determination of block 504 may be made using the header of the packet to determine that this packet is a response packet and came from the on-premise gateway 240. In addition, the first session manager 170 of the first cloud gateway 160 checks the first session table 174. Since this is a response, the first session table 174 of the first cloud gateway will have a record, which was created by the first session manager 170 when the first request was received from VM1 150 of the public cloud network 105. If the record does not have the category set to route, then this is a first response, and, if the record does have the category set to route then this is a subsequent response (i.e., not the first response).

In block 506, the second cloud gateway 180 determines whether this is a first response packet received at the second cloud gateway 180 for the session from the on-premise gateway 240. If this is the first response packet received at the second cloud gateway for the session from an on-premise gateway 240, processing continues to block 522 (FIG. 5D), otherwise, processing continues to block 508.

The determination of block 506 may be made using the header of the packet to determine that this packet is a response packet and came from the on-premise gateway 240. In addition, the second session manager 190 of the second cloud gateway 180 checks the second session table 194. Since this is a response, if the second session table 194 does not have a record (i.e., because the corresponding request was received by the first cloud gateway 160), then this is the first response, and a record will be created. If this is a subsequent response, the second session table 194 would have a record with the category set to redirect.

In block 508, the cloud gateway determines whether this is a first response packet received at the first cloud gateway 160 from the second cloud gateway 180 for the session. If this is a first response packet received at the first cloud gateway 160 from the second cloud gateway 180 for the session, processing continues to block 528, otherwise, processing continues to block 510.

The determination of block 508 may be made using the header of the packet to determine that this packet is a response packet and came from the second cloud gateway 180. In addition, the first session manager 170 of the first cloud gateway 160 checks the first session table 174. Since this is a response, the first session table 174 of the first cloud gateway 160 has a record with the category either blank or set to route.

In block 510, a subsequent packet is received at either the first cloud gateway 160 or the second cloud gateway 180 and is processed based on the category of the record in the session table 174, 194 at that cloud gateway 160, 180. From block 510, processing continues to block 500 (FIG. 5A) to process another packet.

In particular, in block 510, if a subsequent packet is received, and a record in the session table for that subsequent packet indicates that the category is set to route, the subsequent packet is sent to the destination. However, if the record in the session table for that subsequent packet indicates that the category is set to redirect, the subsequent packet is sent via the intra-tunnel 178 to the other cloud gateway, which sends the subsequent packet to the destination.

In FIG. 5B, in block 512, the first session manager 170 of the first cloud gateway 160 creates a record in the first session table 174 for the request packet with the category set to null (or not available, or blank, etc.). In block 514, the first cloud gateway 160 forwards the request packet to the on-premise gateway 240 for forwarding to VM2 230 of the on-premise data center 220. From block 514, processing continues to block 500 (FIG. 5A) to process another packet.

In FIG. 5C, in block 516, the first session manager 170 of the first cloud gateway 160 locates the record in the first session table 174 for the response packet. In block 518, the first cloud gateway 160 sets the category to route for the record. In block 520, the first cloud gateway 160 forwards the response packet to VM1 150 of the public cloud network 105. From block 520, processing continues to block 500 (FIG. 5A) to process another packet.

In FIG. 5D, in block 522, the second cloud gateway 180 determines that there is no record in the second session table 194 for the response packet. In block 524, the second cloud gateway 180 creates a new record in the second session table 194 with the category set to redirect. In block 526, the second cloud gateway 180 forwards the response packet to the first cloud gateway 160 using the intra-tunnel 178, where the first cloud gateway 160 forwards the response packet to VM1 150 of the public cloud network 105. From block 526, processing continues to block 500 (FIG. 5A) to process another packet.

In FIG. 5D, in block 528, the first session manager 170 of the first cloud gateway 160 locates the record in the first session table 174 for the response packet. In block 530, the first cloud gateway 160 sets the category to route for the record. In block 532, the first cloud gateway 160 forwards the response packet to VM1 150 of the public cloud network 105. From block 532, processing continues to block 500 (FIG. 5A) to process another packet.

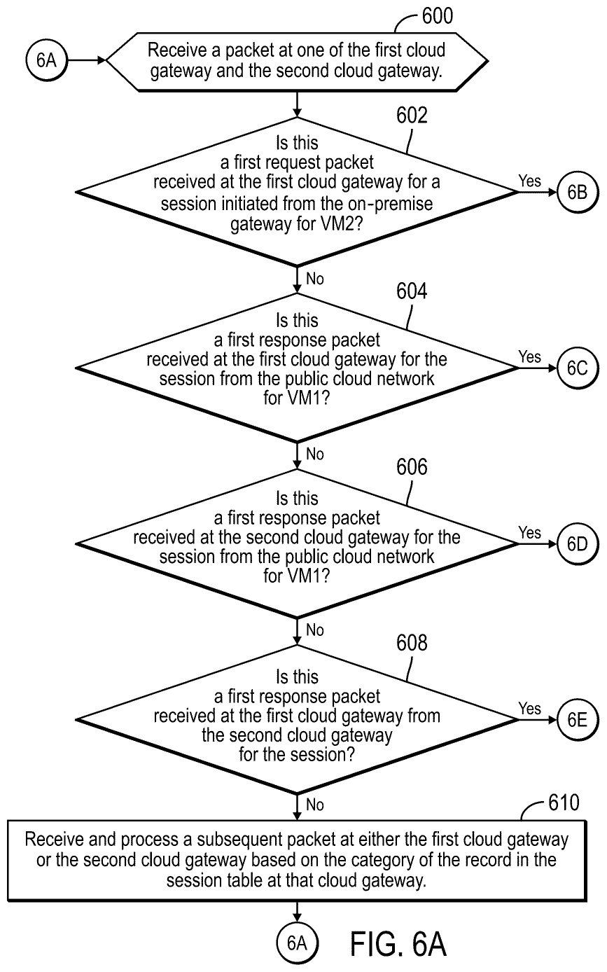

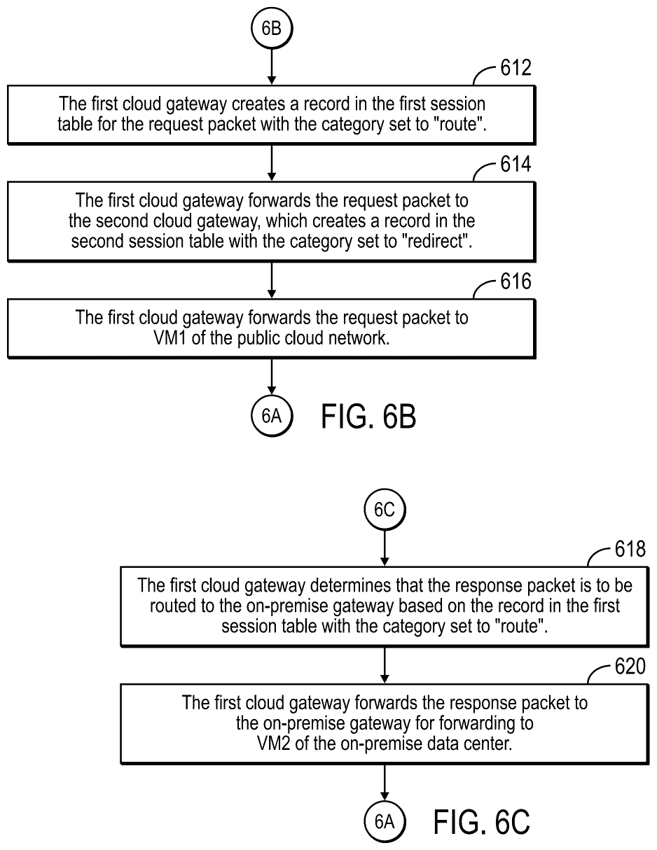

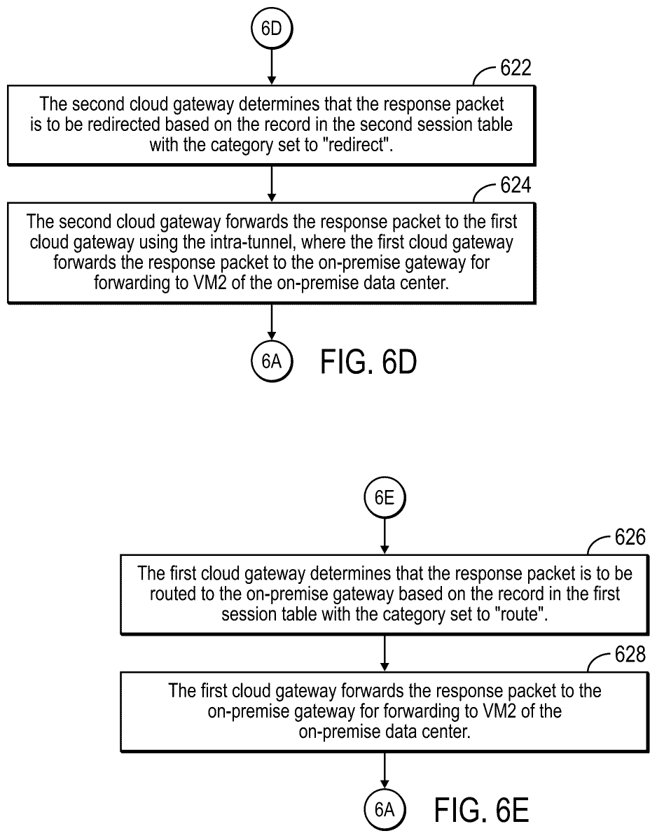

FIGS. 6A-6E illustrate, in a flowchart, operations for traffic that originates at the on-premise gateway in accordance with certain embodiments. Control begins at block 600 a packet being received at one of the first cloud gateway 160 and the second cloud gateway 180.

In block 602, the first cloud gateway 160 determines whether this a first request packet received at the first cloud gateway 160 for a session initiated from the on-premise gateway 105 for VM2 230. If this is the first request packet received from the on-premise gateway 105, processing continues to block 612 (FIG. 6B), otherwise, processing continues to block 604.

The determination of block 602 may be made using the header of the packet to determine that this packet is a request packet and came from the on-premise network 240. In addition, the first session manager 170 of the first cloud gateway 160 checks the first session table 174. If a record for the session is not in the first session table 174 for the packet, then this is the first request, and, if there is a record for the session in the first session table 174 for the packet, then this is not the first request.

In block 604, the first cloud gateway 160 determines whether this a first response packet received at the first cloud gateway for the session from the public cloud network 105 for VM1 150. If this is the first response packet received for the session from VM1 150 of the public cloud network 105, processing continues to block 618 (FIG. 6C), otherwise, processing continues to block 606.

The determination of block 604 may be made using the header of the packet to determine that this packet is a response packet and came from the public cloud network 105. In addition, the first session manager 170 of the first cloud gateway 160 checks the first session table 174. Since this is a response, the first session table 174 of the first cloud gateway will have a record with the category set to route, which was created by the first session manager 170 when the first request was received from VM2 230 of the on-premise network.

In block 606, the second cloud gateway determines whether this is a first response packet received at the second cloud gateway for the session from the public cloud network 105 for VM1 150. If this is the first response packet received at the second cloud gateway for the session from VM1 150 of the public cloud network 105, processing continues to block 622 (FIG. 6D), otherwise, processing continues to block 608.

The determination of block 606 may be made using the header of the packet to determine that this packet is a response packet and came from VM1 150 of the public cloud network 105. In addition, the second session manager 190 of the second cloud gateway 180 checks the second session table 194. Since the corresponding request was received by the first cloud gateway 160 and mirrored to the second cloud gateway, then the session table 194 would have a record with the category set to redirect.

In block 608, the first cloud gateway 160 determines whether this is a first response packet received at the first cloud gateway 160 from the second cloud gateway 180 for the session. If this is the first response packet received at the first cloud gateway 160 from the second cloud gateway 180, processing continues to block 626 (FIG. 6E), otherwise, processing continues to block 610.

The determination of block 508 may be made using the header of the packet to determine that this packet is a response packet and came from the second cloud gateway 180. In addition, the first session manager 170 of the first cloud gateway 160 checks the first session table 174. Since this is a response, the first session table 174 of the first cloud gateway 160 has a record with the category set to route.

In block 610, a subsequent packet is received at either the first cloud gateway 160 or the second cloud gateway 180 and is processed based on the category of the record in the session table 174, 194 at that cloud gateway 160, 180. From block 610, processing continues to block 600 (FIG. 6A) to process another packet.

In particular, in block 610, if a subsequent packet is received, and a record in the session table for that subsequent packet indicates that category is set to route, the subsequent packet is sent to the destination. However, if the record in the session table for that subsequent packet indicates that the category is set to redirect, the subsequent packet is sent via the intra-tunnel 178 to the other cloud gateway, which sends the subsequent packet to the destination.

In FIG. 6B, in block 612, the first cloud gateway 160 creates a record in the first session table 174 for the request packet with the category set to route. In block 614, the first cloud gateway 169 forwards (i.e., mirrors) the request packet to the second cloud gateway 180, which creates a record in the second session table 194 with the category set to redirect. In block 616, the first cloud gateway 160 forwards the request packet to VM1 150 of the public cloud network 105. From block 616, processing continues to block 600 (FIG. 6A) to process another packet.

In FIG. 6C, in block 618, the first cloud gateway 160 determines that the response packet is to be routed to the on-premise gateway 240 based on the record in the first session table with the category set to route. In block 620, the first cloud gateway 160 forwards the response packet to the on-premise gateway 240 for forwarding to VM2 230 of the on-premise data center 220. From block 620, processing continues to block 600 (FIG. 6A) to process another packet.

In FIG. 6D, in block 622, the second cloud gateway 180 determines that the response packet is to be redirected based on the record in the second session table 194 with the category set to “redirect”. In block 624, the second cloud gateway 180 forwards the response packet to the first cloud gateway 160 using the intra-tunnel 178, where the first cloud gateway 160 forwards the response packet to the on-premise gateway 240 for forwarding to VM2 230 of the on-premise data center 220. From block 624, processing continues to block 600 (FIG. 6A) to process another packet.

In FIG. 6E, in block 626, the first cloud gateway 160 determines that the response packet is to be routed to the on-premise gateway 240 based on the record in the first session table with the category set to “route”. In block 628, the first cloud gateway forwards the response packet to the on-premise gateway 240 for forwarding to VM2 230 of the on-premise data center 220. From block 628, processing continues to block 600 (FIG. 6A) to process another packet.

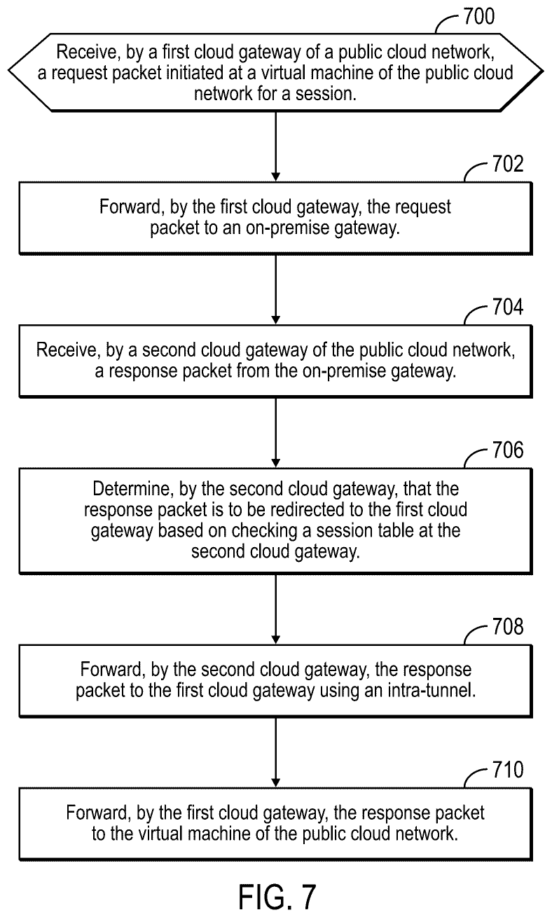

FIG. 7 illustrates, in a flowchart, operations for mitigating asymmetric traffic in accordance with certain embodiments. Control begins at block 700 with a first cloud gateway 160 of a public cloud network 105, a request packet initiated at a virtual machine 150 of the public cloud network 105 for a session. In block 702, the first cloud gateway 160 forwards the request packet to an on-premise gateway 240. In block 704, a second cloud gateway 180 of the public cloud network 105 receives a response packet from the on-premise gateway 240. In block 706, the second cloud gateway 180 determines that the response packet is to be redirected to the first cloud gateway 160 based on checking a session table 194 at the second cloud gateway 180. In particular, the second cloud gateway 180 determines that there is no record for this packet in the second session table 194, creates a new record with the category set to redirect, and forwards this response packet to the first cloud gateway 160. In block 708, the second cloud gateway 180 forwards the response packet to the first cloud gateway using an intra-tunnel. In block 710, the first cloud gateway 160 forwards the response packet to the virtual machine 150 of the public cloud network 105.

Although public cloud 105 is used for embodiments herein, the MAT systems 165, 185 and intra-tunnel 178 are applicable to any network that performs asymmetric routing in various other embodiments.

Although virtual machines 150, 230 are used for embodiments herein, the request and response packets may be sent to and from any type of machine in various other embodiments. Also, in various embodiments, the virtual machines 150, 230 may be software running on computers or may be physical devices.

In addition, although examples have described the first cloud gateway 160 receiving the first requests from the public cloud network 105 and the on-premise gateway 240, the second cloud gateway 160 may also receive first requests from the public cloud network 105 and the on-premise gateway 240 (in which case the first cloud gateway 160 may be sending responses to the second cloud gateway 180 via the intra-tunnel 178).

Moreover, although embodiments describe the first cloud gateway 160, the second cloud gateway 180, and the intra-tunnel 178 between VM1 150 of the public cloud network and the on-premise gateway 240, embodiments may use the first cloud gateway 160, the second cloud gateway 180, and the intra-tunnel 178 between other components that communicate with each other.

While asymmetric routing does not hinder the basic functionality of packet forwarding, it may cause issues for devices such as stateful firewalls and Network Address Translation (NAT) devices. This is because such devices rely on monitoring traffic session status across the same network path. So, when forwarding and return traffic take different paths, such devices are not able to perform properly. However, embodiments enable forwarding and return traffic to use the same network path, which enables the stateful firewalls and NAT devices to perform properly. In particular, the MAT systems 165, 185 and the intra-tunnel 178 work together to avoid these issues.

By utilizing the intra-tunnel 178 between the cloud gateways 160, 180 for return traffic, the traffic appears to originate and terminate at the same cloud gateway 160, 180 from the perspective of the public cloud network 105. This eliminates the need for the public cloud network 105 to be aware of the different forwarding and return network paths, effectively resolving the asymmetric routing problem from its viewpoint.

With embodiments, there are modifications on the cloud gateways 160, 180 to introduce the intra-tunnel functionality. However, there is no need to make changes to the on-premise gateway, which avoids complicating deployment and ongoing maintenance.

Thus, with embodiments, for traffic routed asymmetrically (where the return path differs from the forwarding path), the cloud gateway 160, 180 utilizes the intra-tunnel 178 between cloud gateways 160, 180. In particular, the MAT systems 165, 185 use the intra-tunnel 178 to redirect the traffic to another cloud gateway 160, 180, so that the cloud gateway 160, 180 routes the redirected traffic to the appropriate VM.

In certain embodiments, for public cloud network 105 to on-premise data center 220, the public cloud network 105 sends the packet initiated by VM1 150 to the first cloud gateway 160. The first cloud gateway 160 creates a record for the packet and forwards the packet to the on-premise gateway 240. The on-premise gateway 240 forwards the packet to VM2 230.

Then, VM2 230 sends a response packet back to the on-premise gateway 240. In the case of asymmetric routing, the on-premise gateway 240 forwards the response packet to the second cloud gateway 180 based on a routing technique. This creates an asymmetric routing scenario where the forwarding path (via the first cloud gateway 160) differs from the return path (via the second cloud gateway 180).

With intra-tunnel forwarding, the second cloud gateway 180 recognizes that the response packet is to be directed back to the first cloud gateway 160, 180 for delivery to the public cloud network 105. To achieve this without modifying the on-premise gateway 240, embodiments introduce the intra-tunnel 178 between the cloud gateways 160, 180. The second cloud gateway 180 redirects the response packet through this intra-tunnel 178 to the first cloud gateway 160. The first cloud gateway 160 receives the response packet via the intra-tunnel 178 and forwards the response packet to the public cloud network 105, completing the two-way communication.

The letter designators, such as i, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer-implemented method in a public cloud network comprising a first cloud gateway and a second cloud gateway, comprising operations for:
receiving, by the second cloud gateway, a response packet from an on-premise gateway, wherein the response packet corresponds to a request packet from a virtual machine of the public cloud network that was routed through the first cloud gateway to the on-premise gateway;
determining, by the second cloud gateway, that the response packet is to be redirected to the first cloud gateway based on checking a session table at the second cloud gateway; and
forwarding, by the second cloud gateway, the response packet to the first cloud gateway using an intra-tunnel, wherein the first cloud gateway forwards the response packet to the virtual machine of the public cloud network.

2. The computer-implemented method of claim 1, wherein the operations further comprise:
receiving, by the first cloud gateway, a new response packet from the on-premise gateway; and
creating, by the first cloud gateway, a record in a session table at the first cloud gateway with a category set to route.

3. The computer-implemented method of claim 1, wherein the operations for checking the session table at the second cloud gateway further comprise:
determining, by the second cloud gateway, that there is no record for the response packet in the session table at the second cloud gateway; and
creating, by the second cloud gateway, a record in the session table at the second cloud gateway with a category set to redirect.

4. The computer-implemented method of claim 1, wherein the operations further comprise:
receiving, by the first cloud gateway, a new request packet initiated at the on-premise gateway for another virtual machine;
forwarding, by the first cloud gateway, the new request packet to the virtual machine of the public cloud network; and
forwarding, by the first cloud gateway, the new request packet to the second cloud gateway.

5. The computer-implemented method of claim 4, wherein the operations further comprise:
creating, by the first cloud gateway, a new record in the session table at the first cloud gateway with a category set to route.

6. The computer-implemented method of claim 4, wherein the operations further comprise:
receiving, by the second cloud gateway, the new request packet; and
creating, by the second cloud gateway, a new record in the session table at the second cloud gateway with a category set to redirect.

7. The computer-implemented method of claim 4, wherein the operations further comprise:
receiving, by the second cloud gateway, a new response packet from the public cloud network;
determining, by the second cloud gateway, that the new response packet is to be redirected to the first cloud gateway based on checking the session table at the second cloud gateway; and
forwarding, by the second cloud gateway, the new response packet to the first cloud gateway using the intra-tunnel.

8. A computer program product comprising:
one or more computer-readable storage media at a second cloud gateway of a public cloud network that includes a first cloud gateway; and
program instructions stored on the one or more computer-readable storage media to perform operations comprising:
receiving, by the second cloud gateway, a response packet from an on-premise gateway, wherein the response packet corresponds to a request packet from a virtual machine of the public cloud network that was routed through the first cloud gateway to the on-premise gateway;
determining, by the second cloud gateway, that the response packet is to be redirected to the first cloud gateway based on checking a session table at the second cloud gateway; and
forwarding, by the second cloud gateway, the response packet to the first cloud gateway using an intra-tunnel, wherein the first cloud gateway forwards the response packet to the virtual machine of the public cloud network.

9. The computer program product of claim 8, wherein the first cloud gateway receives a new response packet from the on-premise gateway and creates a record in a session table at the first cloud gateway with a category set to route.

10. The computer program product of claim 8, wherein the operations for checking the session table at the second cloud gateway further comprise:
determining, by the second cloud gateway, that there is no record for the response packet in the session table at the second cloud gateway; and
creating, by the second cloud gateway, a record in the session table at the second cloud gateway with a category set to redirect.

11. The computer program product of claim 8, wherein the first cloud gateway receives a new request packet initiated at the on-premise gateway for another virtual machine, forwards the new request packet to the virtual machine of the public cloud network, and forwards the new request packet to the second cloud gateway.

12. The computer program product of claim 11, wherein the first cloud gateway creates a new record in the session table at the first cloud gateway with a category set to route.

13. The computer program product of claim 11, wherein the operations further comprise:
receiving, by the second cloud gateway, the new request packet; and
creating, by the second cloud gateway, a new record in the session table at the second cloud gateway with a category set to redirect.

14. The computer program product of claim 11, wherein the operations further comprise:
receiving, by the second cloud gateway, a new response packet from the public cloud network;
determining, by the second cloud gateway, that the new response packet is to be redirected to the first cloud gateway based on checking the session table at the second cloud gateway; and
forwarding, by the second cloud gateway, the new response packet to the first cloud gateway using the intra-tunnel.

15. A computer system comprising a public cloud network with a first cloud gateway and a second cloud gateway comprising:
a processor set at;
one or more computer-readable storage media; and
program instructions stored on the one or more computer-readable storage media to cause the processor set to perform operations comprising:
receiving, by the second cloud gateway, a response packet from an on-premise gateway, wherein the response packet corresponds to a request packet from a virtual machine of the public cloud network that was routed through the first cloud gateway to the on-premise gateway;
determining, by the second cloud gateway, that the response packet is to be redirected to the first cloud gateway based on checking a session table at the second cloud gateway; and
forwarding, by the second cloud gateway, the response packet to the first cloud gateway using an intra-tunnel, wherein the first cloud gateway forwards the response packet to the virtual machine of the public cloud network.

16. The computer system of claim 15, wherein the first cloud gateway receives a new response packet from the on-premise gateway and creates a record in a session table at the first cloud gateway with a category set to route.

17. The computer system of claim 15, wherein the operations for checking the session table at the second cloud gateway further comprise:
determining, by the second cloud gateway, that there is no record for the response packet in the session table at the second cloud gateway; and
creating, by the second cloud gateway, a record in the session table at the second cloud gateway with a category set to redirect.

18. The computer system of claim 15, wherein the first cloud gateway receives a new request packet initiated at the on-premise gateway for another virtual machine, forwards the new request packet to the virtual machine of the public cloud network, and forwards the new request packet to the second cloud gateway.

19. The computer system of claim 18, wherein the operations further comprise:
receiving, by the second cloud gateway, the new request packet; and
creating, by the second cloud gateway, a new record in the session table at the second cloud gateway with a category set to redirect.

20. The computer system of claim 18, wherein the operations further comprise:
receiving, by the second cloud gateway, a new response packet from the public cloud network;
determining, by the second cloud gateway, that the new response packet is to be redirected to the first cloud gateway based on checking the session table at the second cloud gateway; and
forwarding, by the second cloud gateway, the new response packet to the first cloud gateway using the intra-tunnel.
